(19) United States
(12) Patent Application Publication
(10) Pub. No.: US 2020/0100435 A1
(43) Pub. Date: Apr. 2, 2020

(54) Plant Growing System

(71) Applicants: Darren J. Gebes, Whitewood, SD (US); Blase Gebes, Whitewood, SD (US)

(72) Inventors: Darren J. Gebes, Whitewood, SD (US); Blase Gebes, Whitewood, SD (US)

(21) Appl. No.: 16/149,922

(22) Filed: Oct. 2, 2018

(51) Int. Cl. A01G 9/02; A01G 24/48; A01G 27/04; A01G 31/06

(52) U.S. Cl. CPC A01G 9/023; A01G 31/06; A01G 27/04; A01G 24/48

(57) ABSTRACT

A plant growing system includes a plurality of containers. Each of the containers includes a perimeter wall having an upper edge and a lower edge. The upper edge bounds an upper opening into the container and the lower edge bounds a lower opening. The perimeter wall includes a top portion adjacent to the upper edge, a bottom portion adjacent to the lower edge and a central portion positioned between the top and bottom portions. The perimeter wall has a slot therein extending downwardly into the upper edge. The slot extends through the top portion and through at least a part of the central portion. A rack for releasably receiving each of the containers is provided such that the containers are vertically aligned with each other.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to plant growing devices and more particularly pertains to a new plant growing device for vertically supporting a plurality of plants to be grown in a hydroponic fashion such that each plan is individually contained for easy removal and attachment to the system as desired.

### BRIEF SUMMARY OF THE INVENTION

An embodiment of the disclosure meets the needs presented above by generally comprising a plurality of containers. Each of the containers includes a perimeter wall having an upper edge and a lower edge. The upper edge bounds an upper opening into the container and the lower edge bounds a lower opening. The perimeter wall includes a top portion adjacent to the upper edge, a bottom portion adjacent to the lower edge and a central portion positioned between the top and bottom portions. The perimeter wall has a slot therein extending downwardly into the upper edge. The slot extends through the top portion and through at least a part of the central portion. A rack for releasably receiving each of the containers is provided such that the containers are vertically aligned with each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front right isometric view of a plant growing system according to an embodiment of the disclosure.

FIG. 2 is a bottom rear isometric view of an embodiment of the disclosure.

FIG. 3 is an in-use, front left isometric view of an embodiment of the disclosure.

FIG. 4 is a front right isometric view of an embodiment of a container of the disclosure.

FIG. 5 is a front right isometric view of an embodiment of a rack of the disclosure.

FIG. 6 is a front right isometric view of an embodiment of the disclosure.

FIG. 7 is a top view of another embodiment of the disclosure.

FIG. 8 is side view of the embodiment shown in FIG. 7 of the disclosure.

### DETAILED DESCRIPTION OF THE INVENTION

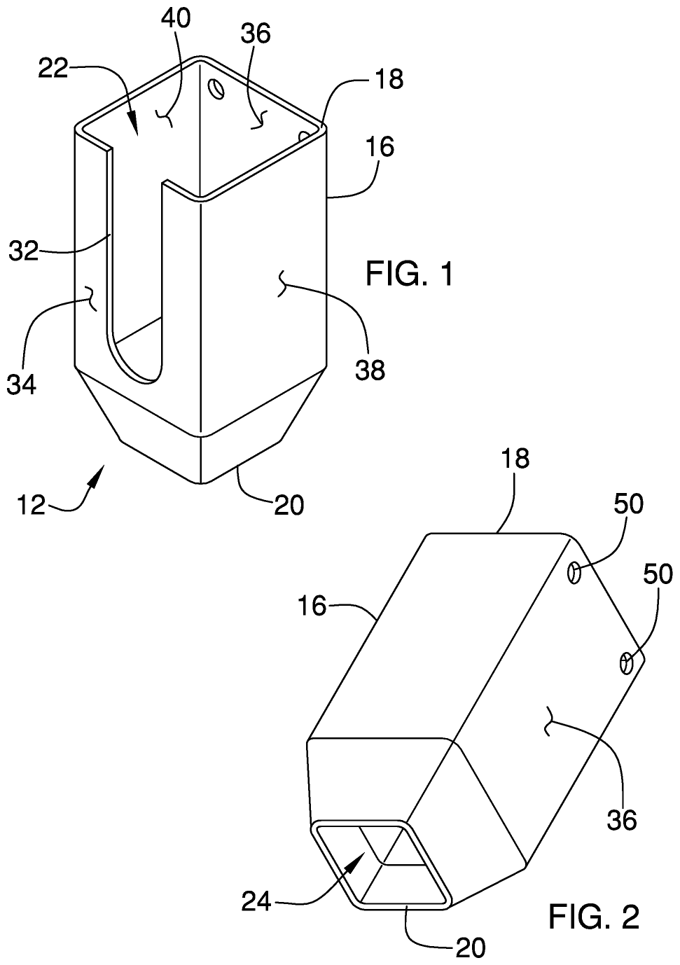

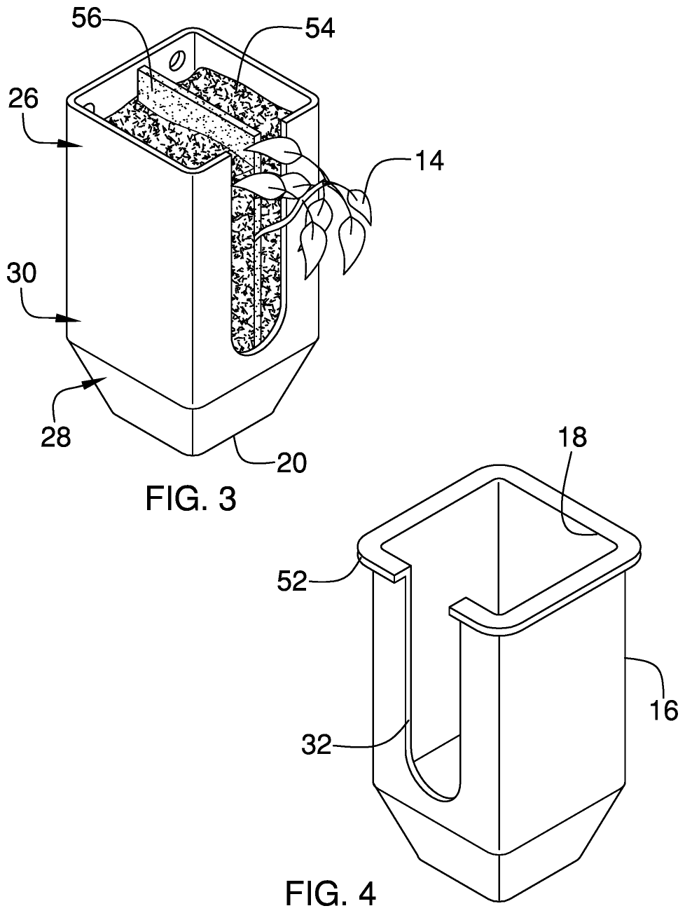

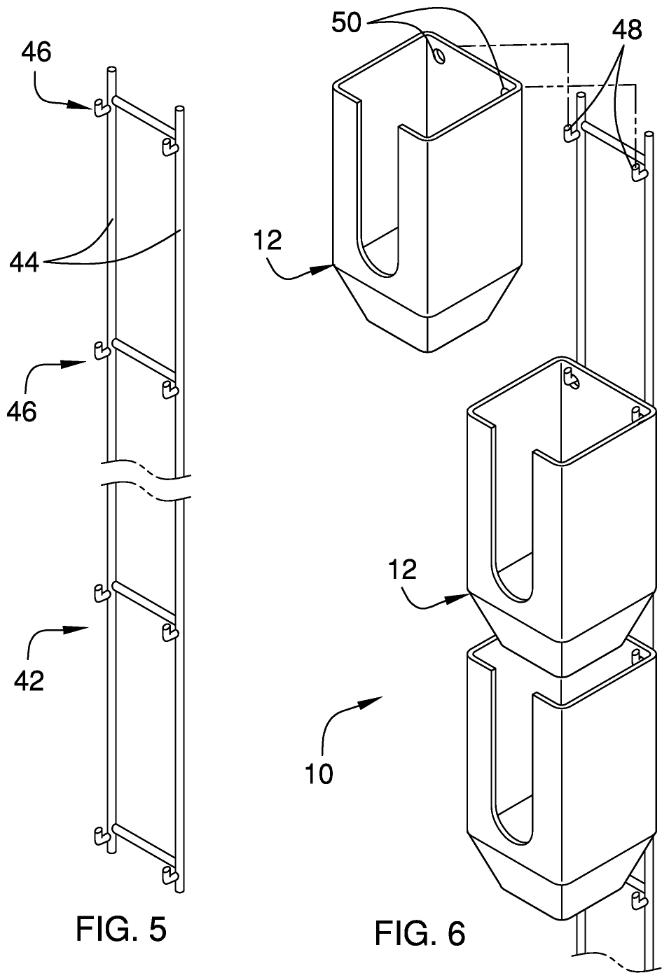

With reference now to the drawings, and in particular to FIGS. 1 through 8 thereof, a new plant growing device embodying the principles and concepts of an embodiment of the disclosure and generally designated by the reference numeral 10 will be described.

As best illustrated in FIGS. 1 through 8, the plant growing system 10 generally comprises a plurality of containers 12 each configured to receive a plant 14. Each of the containers 12 includes a perimeter wall 16 having an upper edge 18 and a lower edge 20. The upper edge 18 bounds an upper opening 22 into the container 12 and the lower edge 20 bounds a lower opening 24. The perimeter wall 16 includes a top portion 26 adjacent to the upper edge 18, a bottom portion 28 adjacent to the lower edge 20 and a central portion 30 positioned between the top 26 and bottom 28 portions. The perimeter wall 16 has a height generally between 4.0 inches and 12.0 inches and the containers each have a diameter generally between 2.5 inches and 6.0 inches.

The perimeter wall 16 has a slot 32 therein extending downwardly into the upper edge 20. The slot 32 extends through the top portion 26 and through part of the central portion 30. The slot 32 is spaced from the bottom portion 28. The bottom portion 28 forms an inwardly tapering funnel from the central portion 30 to the bottom edge 20. This will allow water and roots to extend outwardly of the bottom opening 24 of the container 12 while preventing the plant 14 from falling outwardly of the container 12. The perimeter wall 16 includes a front wall 34, a rear wall 36, a first lateral wall 38 and a second lateral wall 40 such that the upper edge 18 had a rectangular shape. The slot 32 is positioned in the front wall 34 and is spaced from the first 38 and second 40 lateral walls.

A rack 42 releasably receives each of the containers 12 such that the containers 12 are vertically aligned with each other. The rack 42 may be attached to any vertical surface using conventional fasteners. The rack 42 includes a vertical frame 44 and plurality of couplers 46 that is attached to the frame 44. The couplers 46 are vertically spaced from each other. Each of the couplers 46 is releasably engaged with one of the containers 12. In one embodiment, each of the couplers 46 includes a pair of hooks 48 wherein each of the hooks 48 is extendable through the perimeter wall 16 of a corresponding one of the containers 12. Each of the containers 12 therefore has a pair of apertures 50 extending therethrough to receive the hooks 48. The apertures 50 are positioned adjacent to an associated upper edge 18 and more specifically are positioned in the rear walls 36 of the containers 12. Multiple ones of the racks 42 may be attached together laterally to form a large area for supporting the containers 12. As can be seen in FIG. 4, another embodiment of the container 12 includes an upper lip 52 or flange attached to the perimeter wall. This embodiment would be used with a rack 42 wherein the couplers 46 would include rails upon which the upper lip 52 would be positioned.

In order to support the growth of the plants 14, a conventional foam grow media 54 is positioned in each of the containers 12. The foam grow media 54 is typically comprised of a foamed plastic and is impregnated with nutrients. However, other similar materials may include Rockwool, coco fiber, perlite, and other media which are porous and retain their shape such that they not flow outwardly of the bottom openings 24 of the containers 12. Additionally, a conventional wicking material 56 may be positioned in each of the containers 12 and extends through a corresponding one of the foam grow media 54. The wicking material 56 is water absorbent and configured to draw fluid through the foam grow media 54.

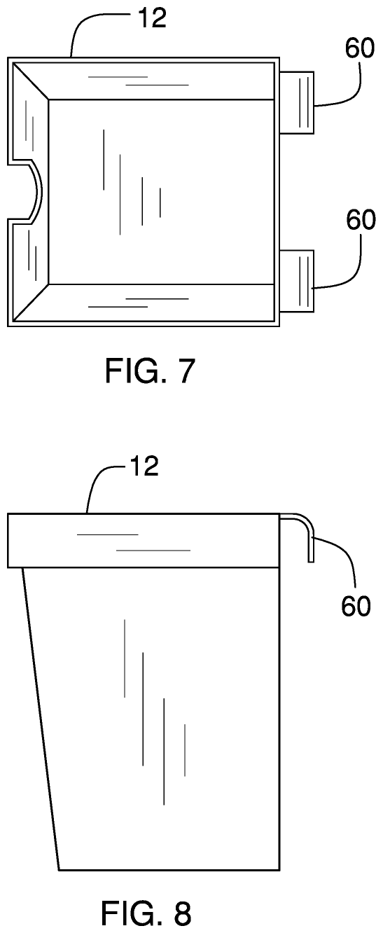

FIGS. 7 and 8 depict another embodiment of the container 12 wherein the container 12 includes one or more connectors 60 instead of the apertures 48 wherein the connectors 60 may be hooked onto the rack 42. However, the connectors 60 also allow for attachment of the containers 12 to other objects which do not include hooks 48 for extending into the apertures 50. For this reason, the connectors 60 comprise hook-shaped members for extending over an edge of any line, rod, frame, wall edge, or the like.

In use, the system 10 is utilized to grow, transport and display individual plants 14 in a hydroponic-like system. The system 10 allows for the mounting of the rack 42 where desired such that the system 10 may be used for display and decorative purposes as well as for growing flowers and vegetables. Additionally, the containers 12 and rack 42 provide an efficient means for selling and transporting plants to and by customers. The containers 12 are partially filled with the foam media 54 and a plant 14 positioned therein such that it may grow outwardly through the slot 32. The plant 14 is then covered with additional grow media 54. The wicking material 56, which may be a strip or panel, extends vertically through the grow media 54 to ensure proper hydration of the grow media 54. As fluid, which may include water and nutrients, flows through the system, it may be collected when as it leaves a bottommost one of the containers 12 positioned on the rack 42. The collected fluid is then re-circulated, for example by a pump, back to an uppermost one of the containers 12. The number of containers 12 per rack 42 may vary depending on the space available and therefore may include as few as three containers 12 and as many as ten or more.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant growing system comprising:
a plurality of containers, each of said containers including:
a perimeter wall having an upper edge and a lower edge, said upper edge bounding an upper opening into said container, said lower edge bounding a lower opening;
said perimeter wall including a top portion adjacent to said upper edge, a bottom portion adjacent to said lower edge and a central portion positioned between said top and bottom portions;
said perimeter wall having a slot therein extending downwardly into said upper edge, said slot extending through said top portion and through at least a part of said central portion;
a rack for releasably receiving each of said containers such that said containers are vertically aligned with each other;
a foam grow media being positioned in each of said containers; and
a wicking material being positioned in each of said containers.

2. The plant growing system according to claim 1, wherein said slot is spaced from said bottom portion.

3. The plant growing system according to claim 1, wherein said bottom portion forms an inwardly tapering funnel from said central portion to said bottom edge.

4. The plant growing system according to claim 3, wherein said perimeter wall includes a front wall, a rear wall, a first lateral wall and a second lateral wall such that said upper edge had a rectangular shape.

5. The plant growing system according to claim 1, wherein said perimeter wall includes a front wall, a rear wall, a first lateral wall and a second lateral wall such that said upper edge had a rectangular shape.

6. The plant growing system according to claim 4, wherein said slot is positioned in said front wall and is spaced from said first and second lateral walls.

7. The plant growing system according to claim 5, wherein said slot is positioned in said front wall and is spaced from said first and second lateral walls.

8. The plant growing system according to claim 4, wherein said rack includes a vertical frame and plurality of couplers being attached to said frame, said couplers being vertically spaced from each other, each of said couplers being releasably engaged with one of said containers.

9. The plant growing system according to claim 8, wherein each of said couplers includes a pair of hooks, each of said hooks being extendable through said perimeter wall of a corresponding one of said containers.

10. The plant growing system according to claim 9, wherein each of said containers has a pair of apertures extending therethrough for receiving said hooks, each of said apertures being positioned adjacent to said upper edge, each of said apertures being positioned in an associated one of said rear walls.

11. The plant growing system according to claim 1, wherein said rack includes a vertical frame and plurality of couplers being attached to said frame, said couplers being vertically spaced from each other, each of said couplers being releasably engaged with one of said containers.

12. The plant growing system according to claim 11, wherein each of said couplers includes a pair of hooks, each of said hooks being extendable through said perimeter wall of a corresponding one of said containers.

13. The plant growing system according to claim 12, wherein each of said containers has a pair of apertures extending therethrough for receiving said hooks, each of said apertures being positioned adjacent to said upper edge.

14. A plant growing system comprising:
a plurality of containers, each of said containers including:
a perimeter wall having an upper edge and a lower edge, said upper edge bounding an upper opening into said container, said lower edge bounding a lower opening;
said perimeter wall including a top portion adjacent to said upper edge, a bottom portion adjacent to said lower edge and a central portion positioned between said top and bottom portions;
said perimeter wall having a slot therein extending downwardly into said upper edge, said slot extending through said top portion and through at least a part of said central portion; and
a rack for releasably receiving each of said containers such that said containers are vertically aligned with each other.

15. The plant growing system according to claim 14, wherein said slot is spaced from said bottom portion.

16. The plant growing system according to claim 15, wherein said bottom portion forms an inwardly tapering funnel from said central portion to said bottom edge.

17. The plant growing system according to claim 16, wherein said perimeter wall includes a front wall, a rear wall, a first lateral wall and a second lateral wall such that said upper edge had a rectangular shape, said slot being positioned in said front wall and is spaced from said first and second lateral walls.

18. The plant growing system according to claim 17, wherein said rack includes a vertical frame and plurality of couplers being attached to said frame, said couplers being vertically spaced from each other, each of said couplers being releasably engaged with one of said containers.

19. The plant growing system according to claim 18, wherein each of said couplers includes a pair of hooks, each of said hooks being extendable through said perimeter wall of a corresponding one of said containers.

20. A plant growing system comprising:
a plurality of containers, each of said containers including:
a perimeter wall having an upper edge and a lower edge, said upper edge bounding an upper opening into said container, said lower edge bounding a lower opening;
said perimeter wall including a top portion adjacent to said upper edge, a bottom portion adjacent to said lower edge and a central portion positioned between said top and bottom portions;
said perimeter wall having a slot therein extending downwardly into said upper edge, said slot extending through said top portion and through part of said central portion, said slot being spaced from said bottom portion;
said bottom portion forming an inwardly tapering funnel from said central portion to said bottom edge;
said perimeter wall including a front wall, a rear wall, a first lateral wall and a second lateral wall such that said upper edge had a rectangular shape;
said slot being positioned in said front wall and being spaced from said first and second lateral walls;
a rack for releasably receiving each of said containers such that said containers are vertically aligned with each other, said rack including a vertical frame and plurality of couplers being attached to said frame, said couplers being vertically spaced from each other, each of said couplers being releasably engaged with one of said containers, each of said couplers including a pair of hooks, each of said hooks being extendable through said perimeter wall of a corresponding one of said containers, each of said containers having a pair of apertures extending therethrough, each of said apertures being positioned adjacent to said upper edge, each of said apertures being positioned in an associated one of said rear walls;
a foam grow media being positioned in each of said containers; and
a wicking material being positioned in each of said containers and extending through a corresponding one of said foam grow media, said wicking material being configured to draw fluid through said foam grown media.
